(19) United States
(12) Patent Application Publication
(10) Pub. No.: US 2025/0291058 A1
(43) Pub. Date: Sep. 18, 2025

(54) OPTICAL SENSING DEVICE

(71) Applicant: GUANGZHOU LUXVISIONS INNOVATION TECHNOLOGY LIMITED, Guangzhou City (CN)

(72) Inventors: Shih-Chieh Yen, Guangzhou City (CN); Chuan-Hui Liu, Guangzhou City (CN)

(73) Assignee: GUANGZHOU LUXVISIONS INNOVATION TECHNOLOGY LIMITED, Guangzhou City (CN)

(21) Appl. No.: 18/935,618

(22) Filed: Nov. 3, 2024

Related U.S. Application Data
(60) Provisional application No. 63/565,491, filed on Mar. 14, 2024.

(30) Foreign Application Priority Data
Jul. 18, 2024 (CN) 202410967497.8

(51) Int. Cl. G01S 17/89

(52) U.S. Cl. CPC G01S 17/89

(57) ABSTRACT

Disclosed is an optical sensing device that includes a wave guide, a light incident grating, a light emitting grating, a sensing element and an imaging component. The light incident grating is attached to a first surface of the wave guide. The light emitting grating is attached to a second surface of the wave guide. The imaging component is disposed between the light emitting grating and the sensing element, and the imaging component from a wave-guide side toward an imaging side sequentially includes a first lens element, a second lens element and a third lens element. The first lens element has a positive refracting power. The second lens element has a negative refracting power. The third lens element has a negative refracting power. There is a total of three lens elements having refracting power in the optical sensing device.

### CROSS-REFERENCE TO RELATED APPLICATION

This application claims the priority benefit of U.S. provisional application Ser. No. 63/565,491, filed on Mar. 14, 2024, and China application serial no. 202410967497.8, filed on Jul. 18, 2024. The entirety of the above-mentioned patent application is hereby incorporated by reference herein and made a part of this specification.

### BACKGROUND

### Technical Field

The disclosure relates to an optical sensing device.

### Description of Related Art

Specifications of portable electronic devices are changing rapidly. An optical sensing device such as an optical imaging device, a 3D distance measuring device, or a mid-infrared gas detection device can be disposed in a portable electronic device. However, the dimension of a portable electronic device is limited. The dimension thereof may restrict the design of an optical sensing device therein.

### SUMMARY

The disclosure provides an optical sensing device. The disposal of each element may have a large margin and is adapted to be accommodated in a narrow space.

According to an embodiment of the disclosure, an optical sensing device includes a wave guide, a light incident grating, a light emitting grating, a sensing element, and an imaging component. The light incident grating is attached to a first surface of the wave guide. The light emitting grating is attached to a second surface of the wave guide. The imaging component is disposed between the light emitting grating and the sensing element, and the imaging component from a wave-guide side toward an imaging side sequentially includes a first lens element, a second lens element and a third lens element. The first lens element has a positive refracting power. The second lens element has a negative refracting power. The third lens element has a negative refracting power. There is a total of three lens elements having refracting power in the optical sensing device.

Based on the above, an optical sensing device provided by the embodiment of the disclosure includes the wave guide and the imaging component. The wave guide is provided with the light incident grating, the light emitting grating and a turning grating. These gratings are thin in thickness that helps the optical sensing device to be accommodated in a narrow space such as in a smartphone. Furthermore, through disposing the wave guide and the gratings thereon, the light path may be changed based on the positions of the gratings to allow the disposal position of the imaging component to be adjustable and also help the optical sensing device to be accommodated in a narrow space. The design margin of the optical sensing device is improved. In addition, through changing characteristics such as the refractive index and spatial frequency of array structures of the gratings, the optical sensing device may be adapted for sensing in various wavelength bands.

In order to make the features and advantages of the disclosure more comprehensible, the following examples are given and described in detail with the accompanying drawings as follows.

### BRIEF DESCRIPTION OF THE DRAWINGS

FIG. 1A is a perspective schematic view of an optical sensing device according to an embodiment of the disclosure.

FIG. 1B is a side schematic view of the optical sensing device of FIG. 1A.

FIG. 2 is a schematic view of the light incident grating, the light emitting grating and the turning grating of FIG. 1A.

FIG. 3A is a partial schematic view of the optical sensing device of FIG. 1A.

FIG. 3B and FIG. 3C are schematic views of field curvature aberrations of the optical sensing device of FIG. 1A.

FIG. 3D is a schematic view of distortions of the optical sensing device of FIG. 1A.

### DESCRIPTION OF THE EMBODIMENTS

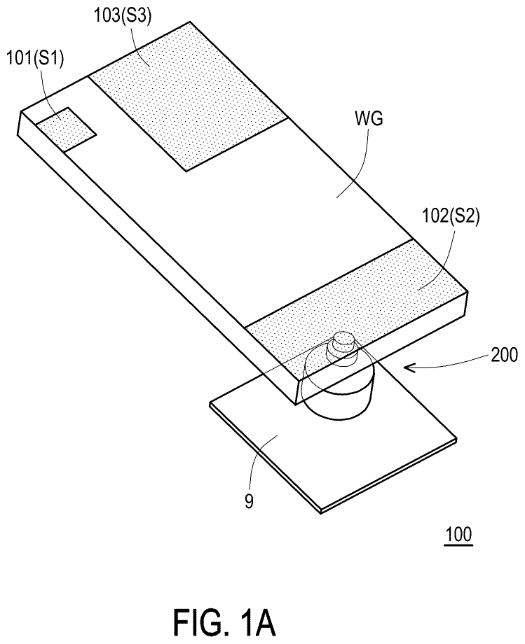

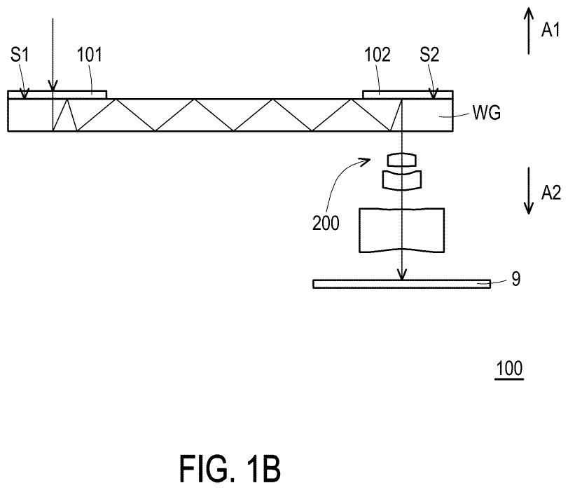

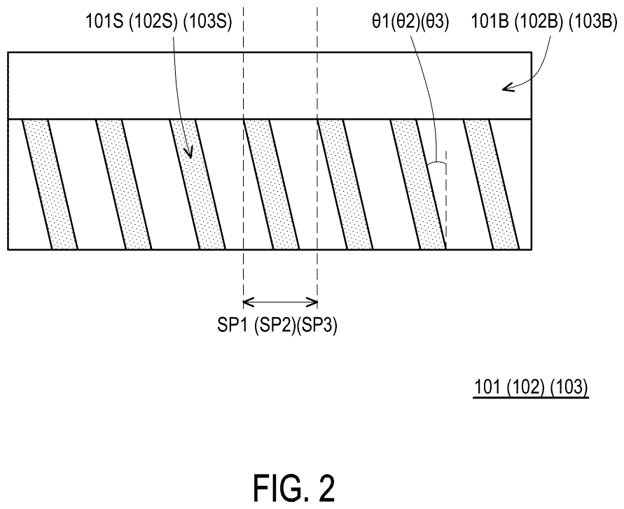

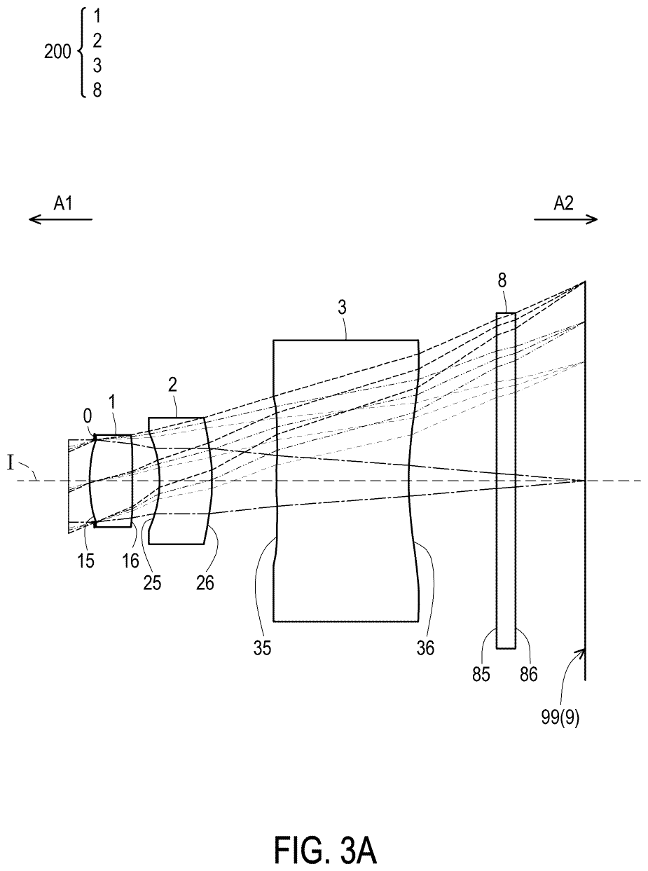

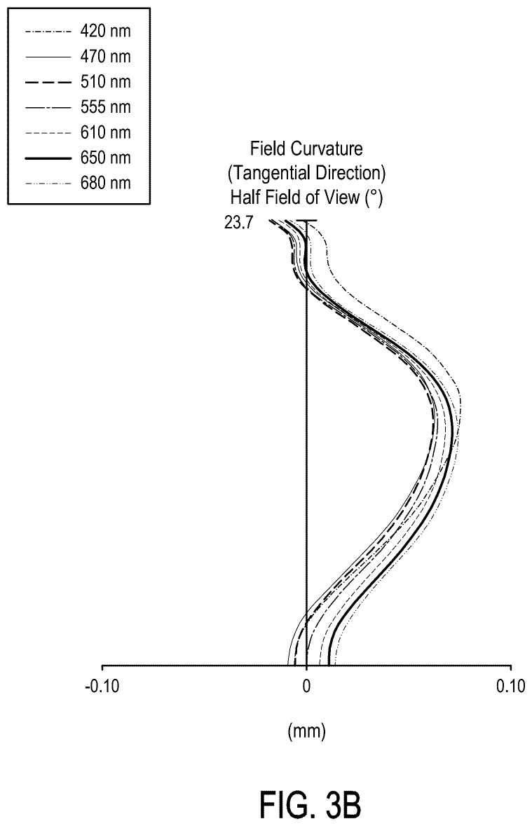

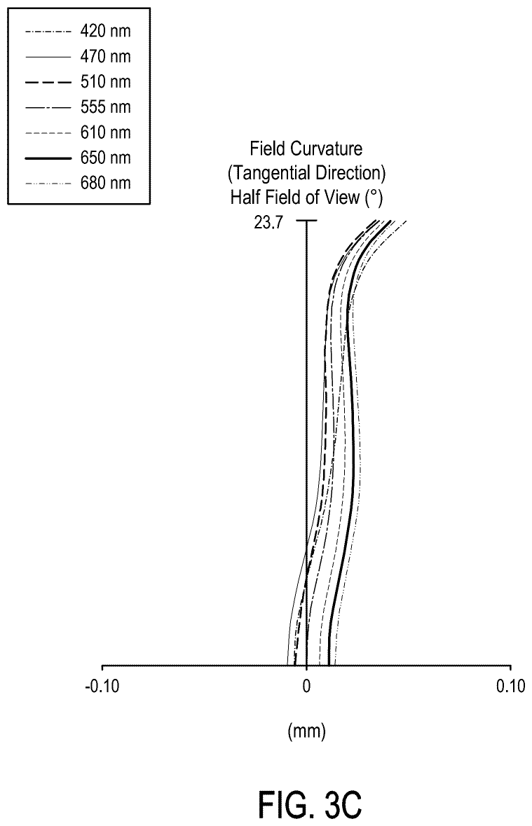

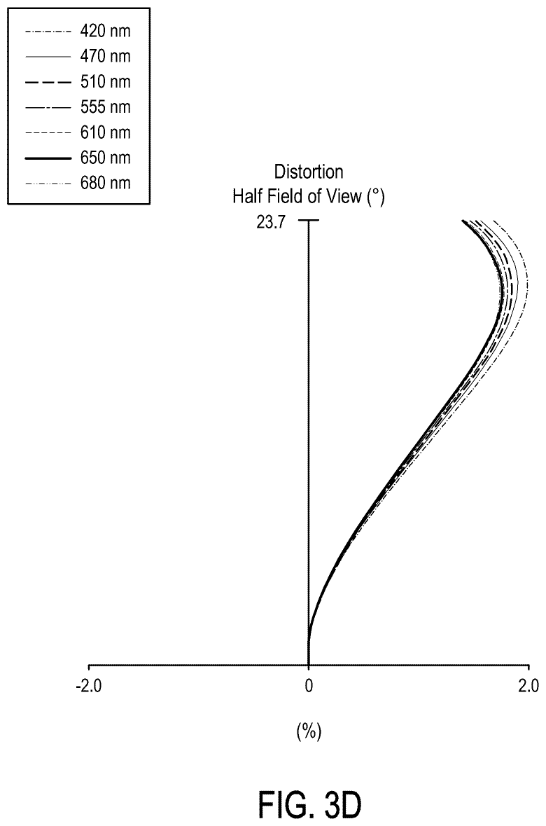

Referring to FIG. 1A, FIG. 1B, FIG. 2 and FIG. 3A, FIG. 1A is a perspective schematic view of an optical sensing device according to an embodiment of the disclosure, FIG. 1B is a side schematic view of the optical sensing device of FIG. 1A, FIG. 2 is a schematic view of the light incident grating, the light emitting grating and the turning grating of FIG. 1A, and FIG. 3A is a partial schematic view of the optical sensing device of FIG. 1A.

An optical sensing device 100 of the embodiment includes a wave guide WG, a light incident grating 101, a light emitting grating 102, a turning grating 103, a sensing element 9, and an imaging component 200. The light incident grating 101 is attached to a first surface S1 of the wave guide WG. The light emitting grating 102 is attached to a second surface S2 of the wave guide WG. The turning grating 103 is attached to a third surface S3 of the wave guide WG. The imaging component 200 is disposed between the light emitting grating 102 and the sensing element 9, and the imaging component 200 from a wave-guide side A1 toward an imaging side A2 sequentially includes a lens element 1, a lens element 2, and a lens element 3. The lens element 1 has a positive refracting power. The lens element 2 has a negative refracting power. The lens element 3 has a negative refracting power. There is a total of three lens elements having refracting power in the optical sensing device.

The light incident grating 101, the light emitting grating 102 and the turning grating 103 of the embodiment have similar structures. For ease of understanding, the three gratings are all indicated by the structure shown in FIG. 2. Specifically, the refractive indices of a substrate 101B of the light incident grating 101, a substrate 102B of the light emitting grating 102, and a substrate 103B of the turning grating 103 all fall between 1.5 and 2.0. The refractive indices of an array structure 101S of the light incident grating 101, an array structure 102S of the light emitting grating 102, and an array structure 103S of the turning grating 103 all fall between 1.5 and 4.0.

A tilt angle θ1 of the array structure 101S of the light incident grating 101 and a tilt angle θ2 of the array structure 102S of the light emitting grating 102 fall between 0 degrees and 45 degrees, or preferably fall between 30 degrees and 45 degrees. A tilt angle θ3 of the array structure 103S of the turning grating 103 falls between 0 degrees and 20 degrees. The tilt angle θ1, θ2 or θ3 refers to an angle between the corresponding array structure 101S, 102S or 103S and a normal line of the corresponding substrate 101B, 102B or 103B.

A space cycle SP1 of the array structure 101S of the light incident grating 101 and a space cycle SP2 of the array structure 102S of the light emitting grating 102 fall within a range of 500 nm to 700 nm. A space cycle SP3 of the array structure 103S of the turning grating 103 falls within a range of 200 nm to 400 nm. The space cycle SP1, SP2 or SP3 refers to a distance at which a same structure of the corresponding array structure 101S, 102S or 103S repeatedly appears in space.

The height of the array structure 101S of the light incident grating 101 in the thickness direction of the light incident grating 101 falls within a range of 300 nm to 800 nm. The height of the array structure 102S of the light emitting grating 102 in the thickness direction of the light emitting grating 102 falls within a range of 300 nm to 800 nm. The height of the array structure 103S of the turning grating 103 in the thickness direction of the turning grating 103 falls within a range of 300 nm to 800 nm. The light incident grating 101, the light emitting grating 102 and the turning grating 103 are thin in thickness that helps the optical sensing device 100 to be accommodated in a narrow space.

In the embodiment, the first surface S1 on which the light incident grating 101 is disposed and the second surface S2 on which the light emitting grating 102 is disposed are located on a same side of the wave guide WG, but the disclosure is not limited thereto. In other embodiments, the first surface S1 and the second surface S2 may be respectively located on opposite sides of the wave guide WG.

The light incident on the optical sensing device 100 transmits the light incident grating 101 before being delivered in the wave guide WG. The light may be turned by the turning grating 103 and continues to be delivered in the wave guide WG. After transmitting the light emitting grating 102, the light continues to transmit the imaging component 200 and is focused on the sensing element 9. Through disposing the wave guide WG and the light incident grating 101, the light emitting grating 102 and the turning grating 103 thereon, the light path may be changed based on the positions of the gratings to allow the disposal position of the imaging component 200 to be adjustable and help the optical sensing device 100 to be accommodated in a narrow space. The design margin of the optical sensing device 100 is significantly improved.

The imaging component 200 from the wave-guide side A1 to the imaging side A2 along an optical axis I of the imaging component 200 sequentially includes an aperture 0, a lens element 1, a lens element 2, a lens element 3, and a filter 8. After a light emitted by an object to be sensed enters the imaging component 200 and sequentially transmits the aperture 0, the lens element 1, the lens element 2, the lens element 3 and the filter 8, an image is formed on an image plane 99 of the sensing element 9. The filter 8 is, for example, an infrared cut-off filter that may allow lights with suitable wavelengths (such as infrared light or visible light) to pass through and filter out an infrared wavelength band that is intended to be filtered out. The filter 8 is disposed between the lens element 3 and the image plane 99. It is additionally noted that the wave-guide side A1 refers to a side facing the wave guide WG, and the imaging side A2 refers to a side facing the image plane 99.

In the embodiment, the lens element 1, the lens element 2, the lens element 3 and the filter 8 of the imaging component 200 individually have object-side surfaces 15, 25, 35 and 85 facing the wave-guide side A1 and allowing an imaging light to pass through, and image-side surfaces 16, 26, 36 and 86 facing the imaging side A2 and allowing an imaging light to pass through. In the embodiment, the aperture 0 is disposed on the wave-guide side A1 of the lens element 1.

The lens element 1 has a positive refracting power. An optical-axis region of the object-side surface 15 thereof is convex, an optical-axis region of the image-side surface 16 is convex, and the object-side surface 15 and the image-side surface 16 both are aspheric surfaces. The lens element 1 is a biconvex lens.

The lens element 2 has a negative refracting power. An optical-axis region of the object-side surface 25 thereof is concave, an optical-axis region of the image-side surface 26 is convex, and the object-side surface 25 and the image-side surface 26 both are aspheric surfaces. The lens element 2 is a negative meniscus lens with a concave surface facing the wave-guide side A1.

The lens element 3 has a negative refracting power. An optical-axis region of the object-side surface 35 thereof is convex, an optical-axis region of the image-side surface 36 is concave, and the object-side surface 35 and the image-side surface 36 both are aspheric surfaces. The lens element 3 is a negative meniscus lens with a concave surface facing the imaging side A2.

Other detailed optical data of the imaging component 200 are shown in Table 1.

TABLE 1

| | | Radius of | | | |
|---|---|---|---|---|---|
| | | Curvature | Spacing | Refractive | Abbe |
| Element | Surface | (mm) | (mm) | Index | Number |
| Object | | Infinite | Infinite | | |
| Aperture 0 | | Infinite | −0.050 | | |
| Lens element | Object-Side | 1.60 | 0.488 | 1.545 | 55.987 |
| 1 | Surface 15 | | | | |
| | Image-Side | −13.13 | 0.306 | | |
| | Surface 16 | | | | |
| Lens element | Object-Side | −1.25 | 0.596 | 1.642 | 22.409 |
| 2 | Surface 25 | | | | |
| | Image-Side | −2.05 | 0.729 | | |
| | Surface 26 | | | | |
| Lens element | Object-Side | 14.67 | 1.500 | 1.545 | 55.987 |
| 3 | Surface 35 | | | | |
| | Image-Side | 4.04 | 1.000 | | |
| | Surface 36 | | | | |
| Filter 8 | Object-Side | Infinite | 0.210 | 1.517 | 64.167 |
| | Surface 85 | | | | |
| | Image-Side | Infinite | 0.790 | | |
| | Surface 86 | | | | |
| | Image Plane | Infinite | | | |
| | 99 | | | | |

In Table 1, the spacing of the object-side surface 15 (0.488 mm as shown in Table 1) is the thickness of the lens element 1 on the optical axis I, and the spacing of the image-side surface 16 (0.306 mm as shown in Table 1) is the distance between the image-side surface 16 of the lens element 1 and the object-side surface 25 of the lens element 2 on the optical axis I, that is, the gap between the lens element 1 and the lens element 2 on the optical axis I, and so on.

In the embodiment, the object-side surfaces 15, 25 and 35 of the lens element 1, the lens element 2 and the lens element 3, and the image-side surfaces 16, 26 and 36 of the lens element 1, the lens element 2 and the lens element 3 are all aspheric surfaces, and these aspheric surfaces are defined according to the following formula (1):

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

Y: a distance between a point on the aspheric curve and the optical axis;
Z: an aspheric depth, that is, a vertical distance between a point on the aspheric surface that is Y from the optical axis and a tangent plane that is tangent to the vertex on the optical axis of the aspheric surface;
R: a radius of curvature of a lens surface;
K: the cone coefficient;
a₂ᵢ: the 2i-th order aspheric coefficient.

In the embodiment, the cone coefficient K and various aspheric coefficients in the foregoing aspheric formula (1) are shown in Table 2. In Table 2, number 15 indicates the aspheric coefficient of the object-side surface 15 of the lens element 1, number 16 indicates the aspheric coefficient of the image-side surface 16 of the lens element 1, and so on for other numbers.

TABLE 2

| Surface | K | a₄ | a₆ | a₈ |
|---|---|---|---|---|
| 15 | 0.00E+00 | 8.39836E−02 | −4.12188E+00 | 8.59851E+01 |
| 16 | 0.00E+00 | −2.78382E−02 | −2.21359E+00 | 4.05320E+01 |
| 25 | 0.00E+00 | −5.03707E−02 | 3.78828E+00 | −4.80789E+01 |
| 26 | 0.00E+00 | 6.37569E−02 | 1.80991E−01 | 4.34209E−02 |
| 35 | 0.00E+00 | −6.65315E−02 | −2.63673E−03 | 6.23282E−05 |
| 36 | 0.00E+00 | −1.55592E−01 | −3.99711E−04 | 7.19249E−04 |
| Surface | a₁₀ | a₁₂ | a₁₄ | a₁₆ |
| 15 | −9.59098E+02 | 5.77404E+03 | −1.77170E+04 | 2.17085E+04 |
| 16 | −4.04887E+02 | 2.17089E+03 | −5.96137E+03 | 6.59649E+03 |
| 25 | 3.22651E+02 | −1.16109E+03 | 2.07030E+03 | −1.36822E+03 |
| 26 | −4.81341E+00 | 2.27132E+01 | −4.29554E+01 | 3.00206E+01 |
| 35 | 6.66908E−05 | 7.50809E−05 | 3.61854E−05 | 2.15311E−05 |
| 36 | −2.79283E−04 | 1.48755E−04 | −2.03771E−05 | 2.90975E−05 |

Further referring to FIG. 3B to FIG. 3D, FIG. 3B is a graph of field curvature aberrations in a tangential direction when lights with respective wavelengths of 420 nm, 470 nm, 510 nm, 555 nm, 610 nm, 650 nm and 680 nm are incident on the imaging component 200, FIG. 3C is a graph of field curvature aberrations in a sagittal direction when lights with respective wavelengths of 420 nm, 470 nm, 510 nm, 555 nm, 610 nm, 650 nm and 680 nm are incident on the imaging component 200, and FIG. 3D is a graph of distortions when lights with respective wavelengths of 420 nm, 470 nm, 510 nm, 555 nm, 610 nm, 650 nm and 680 nm are incident on the imaging component 200.

As shown in the field curvature aberration graphs of FIG. 3B and FIG. 3C, the field curvature aberrations of the seven representative wavelengths in the entire field of view fall within +0.08 mm that indicates that the imaging component 200 may effectively eliminate field curvature aberrations. As shown in the distortion graph of FIG. 3D, the distortion aberrations of the seven representative wavelengths in the entire field of view is less than +2% that indicates that the imaging component 200 has good imaging quality.

Based on the above, the optical sensing device provided by the embodiment of the disclosure includes the wave guide and the imaging component. The wave guide is provided with the light incident grating, the light emitting grating and the turning grating. These gratings is thin in thickness that helps the optical sensing device to be accommodated in a narrow space such as in a smartphone. Furthermore, through disposing the wave guide and the gratings thereon, the light path may be changed based on the positions of the gratings to allow the disposal position of the imaging component to be adjustable and also help the optical sensing device to be accommodated in a narrow space. The design margin of the optical sensing device is improved. In addition, through changing characteristics such as the refractive index and spatial frequency of the array structures of the gratings, the optical sensing device may be adapted for sensing in various wavelength bands.

What is claimed is:

1. An optical sensing device, comprising:
a wave guide;
a light incident grating, attached to a first surface of the wave guide;
a light emitting grating, attached to a second surface of the wave guide;
a sensing element; and
an imaging component, disposed between the light emitting grating and the sensing element, and the imaging component from a wave-guide side toward an imaging side sequentially comprising:
a first lens element, having a positive refracting power;
a second lens element, having a negative refracting power; and
a third lens element, having a negative refracting power,
wherein there is a total of three lens elements having refracting power in the optical sensing device.

2. The optical sensing device according to claim 1, wherein refractive indices of substrates of the light incident grating and the light emitting grating fall between 1.5 and 2.0, and refractive indices of array structures of the light incident grating and the light emitting grating fall between 1.5 and 4.0.

3. The optical sensing device according to claim 2, wherein tilt angles of the array structures of the light incident grating and the light emitting grating fall between 0 degrees and 45 degrees.

4. The optical sensing device according to claim 1, wherein the first surface and the second surface are located on a same side of the wave guide.

5. The optical sensing device according to claim 1, wherein the first surface and the second surface are located on opposite sides of the wave guide.

6. The optical sensing device according to claim 1, further comprising a turning grating that is attached to a third surface of the wave guide.

7. The optical sensing device according to claim 3, wherein space cycles of the array structures of the light incident grating and the light emitting grating fall within a range of 50 nm to 700 nm.

8. The optical sensing device according to claim 1, wherein the first lens element is a double convex lens.

9. The optical sensing device according to claim 8, wherein the second lens element is a negative meniscus lens with a concave surface facing the wave-guide side.

10. The optical sensing device according to claim 9, wherein the third lens element is a negative meniscus lens with a concave surface facing the imaging side.

11. The optical sensing device according to claim 3, wherein the tilt angles of the array structures of the light incident grating and the light emitting grating fall between 30 degrees and 45 degrees.

12. The optical sensing device according to claim 6, wherein a tilt angle of an array structure of the turning grating falls between 0 degrees and 20 degrees.

13. The optical sensing device according to claim 6, wherein a space cycle of an array structure of the turning grating falls within a range of 200 nm to 400 nm.
